(19) United States
(12) Patent Application Publication
(10) Pub. No.: US 2016/0014237 A1
(43) Pub. Date: Jan. 14, 2016

(54) COMMUNICATION DEVICE, COMMUNICATION METHOD, AND COMPUTER-READABLE RECORDING MEDIUM

(71) Applicants: KABUSHIKI KAISHA TOSHIBA, Tokyo (JP); TOSHIBA SOLUTIONS CORPORATION, Kawasaki-shi (JP)

(72) Inventors: Kentaro Kamahora, Tokyo (JP); Naoki Iketani, Tokyo (JP)

(21) Appl. No.: 14/865,313

(22) Filed: Sep. 25, 2015

Related U.S. Application Data
(63) Continuation of application No. PCT/JP2013/059314, filed on Mar. 28, 2013.

(51) Int. Cl. H04L 29/06; H04L 12/801; H04L 12/741; H04W 72/04

(52) U.S. Cl. CPC H04L 69/04; H04W 72/0446; H04L 47/11; H04L 45/74

(57) ABSTRACT

A communication device includes a determining unit that determines whether a received communication packet is to be compressed, a storage unit that stores therein the communication packet determined to be compressed, an analyzing unit that analyzes a plurality of stored communication packets, and determines whether the communication packets include any similar packets having similar process requests, based on a result of analysis, a compressing unit that compresses the communication packets corresponding to the similar packets when the communication packets are determined to include some similar packets, and a communicating unit that transmits the compressed communication packet.

### CROSS-REFERENCE TO RELATED APPLICATIONS

This application is a continuation of International Application No. PCT/JP2013/059314, filed on Mar. 28, 2013, the entire contents of which are incorporated herein by reference.

### FIELD

Embodiments according to a present invention relate generally to a communication device, a communication method, and a computer-readable recording medium.

### BACKGROUND

Various types of services such as web services, content distribution services, and storage services are now provided over telecommunication circuits such as a network. Because such network services are now widely provided by a cloud system, an access concentration in the cloud system may lead to overload of a server managing the network service or a communication path to the server, and the quality of the service provided by the cloud system becomes deteriorated. To address this issue, conventionally known is a technology for suppressing the quality degradation of a service due to the access concentration.

Such a conventional technology, however, is not intended to alleviate load of both of the server and the communication path.

### BRIEF DESCRIPTION OF THE DRAWINGS

FIG. 1 is a diagram illustrating an exemplary configuration of a communication system according to a first embodiment;

FIG. 2 is a schematic diagram illustrating a communication control function according to the first embodiment;

FIG. 3 is a diagram illustrating an exemplary functional configuration of the communication device according to the first embodiment;

FIGS. 4A and 4B are diagrams illustrating exemplary data of server lists according to the first embodiment;

FIG. 5 is a diagram illustrating exemplary data of decompression information according to the first embodiment;

FIG. 6 is a diagram illustrating an exemplary operation of the communication device according to the first embodiment;

FIG. 7 is a flowchart illustrating an exemplary process performed by the communication device according to the first embodiment;

FIG. 8 is a diagram illustrating an exemplary functional configuration of the communication device according to a second embodiment;

FIGS. 9A and 9B are diagrams illustrating comparative examples of operations with and without some similar packets arriving within the same slot;

FIG. 10 is a flowchart illustrating an exemplary process performed by an adjusting unit according to the second embodiment;

FIG. 11 is a flowchart illustrating an exemplary process performed by an adjusting unit according to a first modification;

FIG. 12 is a diagram generally illustrating a communication control function according to a second modification;

FIG. 13 is a flowchart illustrating an exemplary process performed by a communicating unit according to the second modification; and

FIGS. 14A and 14B are diagrams illustrating exemplary configurations of the communication device according to the embodiments.

### DETAILED DESCRIPTION

Some embodiments of a communication device, a communication method, and a computer-readable recording medium will be explained in detail with reference to the appended drawings.

### First Embodiment

Overview

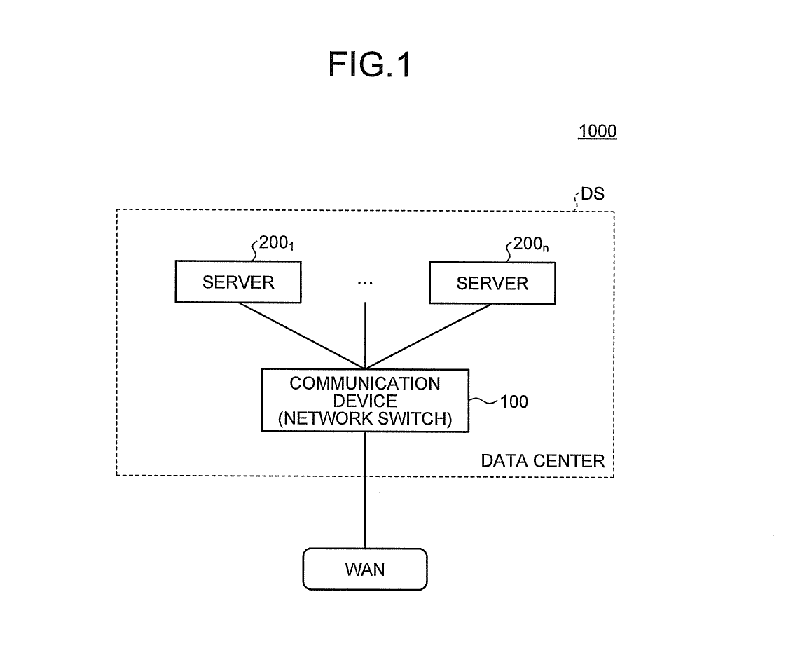

FIG. 1 is a diagram illustrating an exemplary configuration of a communication system 1000 according to a first embodiment. As illustrated in FIG. 1, the communication system 1000 according to the embodiment includes a plurality of servers 200₁ to 200ₙ (hereinafter, collectively referred to as “servers 200”) and a communication device 100 that are deployed in a data center DS. The servers 200 are devices (information processing devices) for managing network services, for example. The servers 200 provide various types of network services by receiving a request for a process, performing the process in response to the request, and making a response by transmitting the result of the process. The communication device 100 is a device including a network switch, for example. The communication device 100 receives a communication packet over a wide area network (WAN), and controls to transfer the communication packet to the corresponding server 200.

The communication system 1000 according to the embodiment with such a configuration operates in the manner described below. The communication device 100 receives a communication packet (a packet requesting for a process) over a wide area network, and transfers the communication packet to the corresponding server 200. In response to a process request defined in the received communication packet, the server 200 performs a predetermined requested process, and transfers the communication packet containing the result of the process (the packet responding to the process) to the communication device 100. The communication device 100 then transmits the received communication packet to the requestor. In this manner, the communication system 1000 according to the embodiment provides a network service by responding to the requestor of a process (such as a “client”) with the result of the process. In other words, the communication system 1000 according to the embodiment is an example of a cloud system that provides various types of network services using the data center DS.

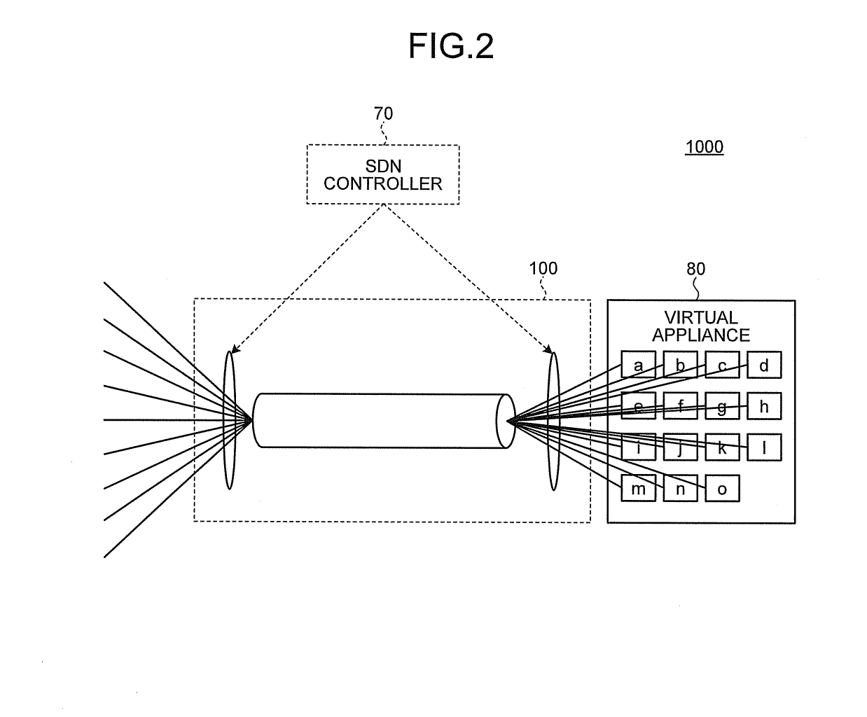

FIG. 2 is a schematic diagram illustrating a communication control function according to the embodiment. The communication control function according to the embodiment (the functions provided to the communication system 1000) includes a software-defined network (SDN) controller 70 and a virtual appliance 80. The SDN controller 70 implements a routing function using software, and controls one or more of communication devices 100. Because the SDN controller 70 is capable of controlling the communication device 100 from the application layer, for example, the SDN controller 70 can associate a network service to a communication device 100. The virtual appliance 80 is a virtual machine environment for implementing a plurality of server functions (the functions “a” to “o” in FIG. 2) on one information processing device (for example, “a server 200”) using a virtualization technology. In the virtual appliance 80, server functions corresponding to network service providers are implemented at a high density.

The communication control function according to the embodiment control inputs and outputs (IOs) to and from the virtual appliance 80 by causing the SDN controller 70 to control the communication device 100 in such an environment.

Functions of Communication Device 100

A communication function according to the embodiment (function provided to the communication device 100) will now be explained. The communication device 100 according to the embodiment temporarily stores (buffers) therein received communication packets. The communication device 100 according to the embodiment then determines whether there are any communication packets with similar process requests (similar packets), based on the result of analysis of the communication packet temporarily stored. If there are any similar packets, the communication device 100 according to the embodiment compresses a plurality of communication packets corresponding to the similar packets into one communication packet, and transmits the resultant communication packet to the server 200 from which the process is requested. The communication device 100 according to the embodiment has such a communication function.

Cloud systems providing various types of network services are now widely deployed, and various solutions such as virtual appliances and the like are used to reduce the time required for a cloud system to provide a network service. In such a cloud system, however, the accesses concentration may lead to overload of a server 200 managing the network service and the communication path to the server 200, and degradation of the quality of the service provided by the cloud system becomes an issue. To alleviate the overload, for example, caches or load balancers have been widely deployed in accordance with the load. There is also a conventional technology for reducing the latency and improving the bandwidth usage by combining and compressing a plurality of communication packets that are received within a predetermined time period.

However, such conventional technologies are not intended to alleviate the load of both of the server 200 and the communication path to the servers 200. The technology for reducing the latency and improving the bandwidth usage by compressing the communication packets that are received within a predetermined time period, for example, has a following problem. Because this technology does not take the similarity between the process requests among a plurality of communication packets to be compressed into consideration, the compressed communication packet needs to be decompressed once in the midway along the communication path, because the server 200 needs to know the process of which network service the communication packet is requesting. This technology is therefore incapable of reducing the load of the server 200. As described above, while the conventional technology is capable of alleviating the load of the communication path to the server 200, the conventional technology is incapable of alleviating the load of the server 200 itself.

The communication device 100 according to the embodiment therefore provides a mechanism, for network services providing static content such as a storage service, for collectively compressing a plurality of communication packets with similar process requests, and transmitting the resultant communication packet to the server 200 that is the addressee of the process request.

With such a mechanism, the communication device 100 according to the embodiment can alleviate the load of both of the server 200 and the communication path to the server 200, and therefore, the IO performance of a cloud infrastructure providing high density network services with a virtual appliance 80 can be improved.

A configuration and an operation of the function (communication function) of the communication device 100 according to the embodiment will now be explained.

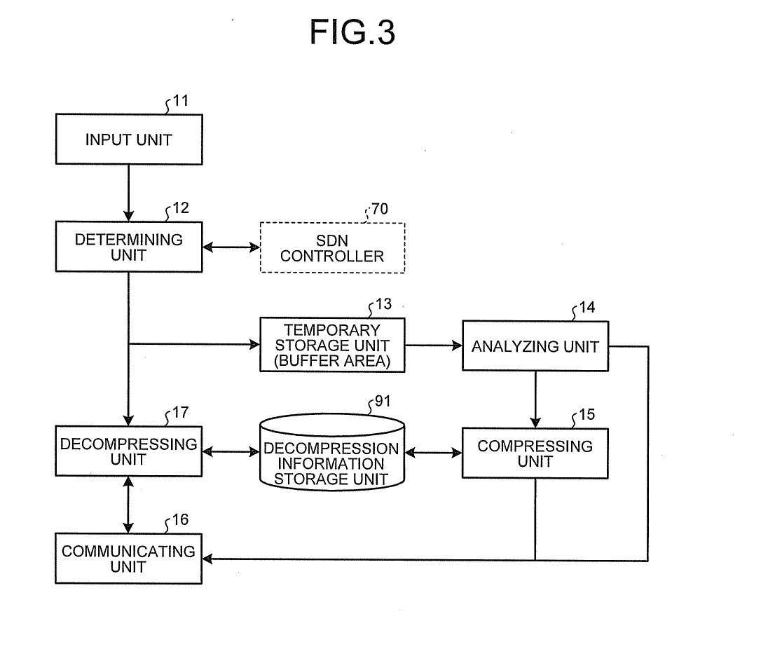

FIG. 3 is a diagram illustrating an exemplary functional configuration of the communication device 100 according to the embodiment. As illustrated in FIG. 3, the communication device 100 according to the embodiment includes an input unit 11, a determining unit 12, a temporary storage unit 13, an analyzing unit 14, a compressing unit 15, a communicating unit 16, a decompressing unit 17, and a decompression information storage unit 91.

The input unit 11 receives inputs of communication packets traversing the communication device 100. The input unit 11 receives the communication packets transmitted to the communication device 100, and acquires the communication packets traversing the communication device 100.

The determining unit 12 determines whether traversing communication packets are to be compressed. The determining unit 12 determines whether a communication packet is to be compressed by determining whether the destination defined in the communication packet received by the input unit 11 is managed as a destination for which the communication packets are to be compressed.

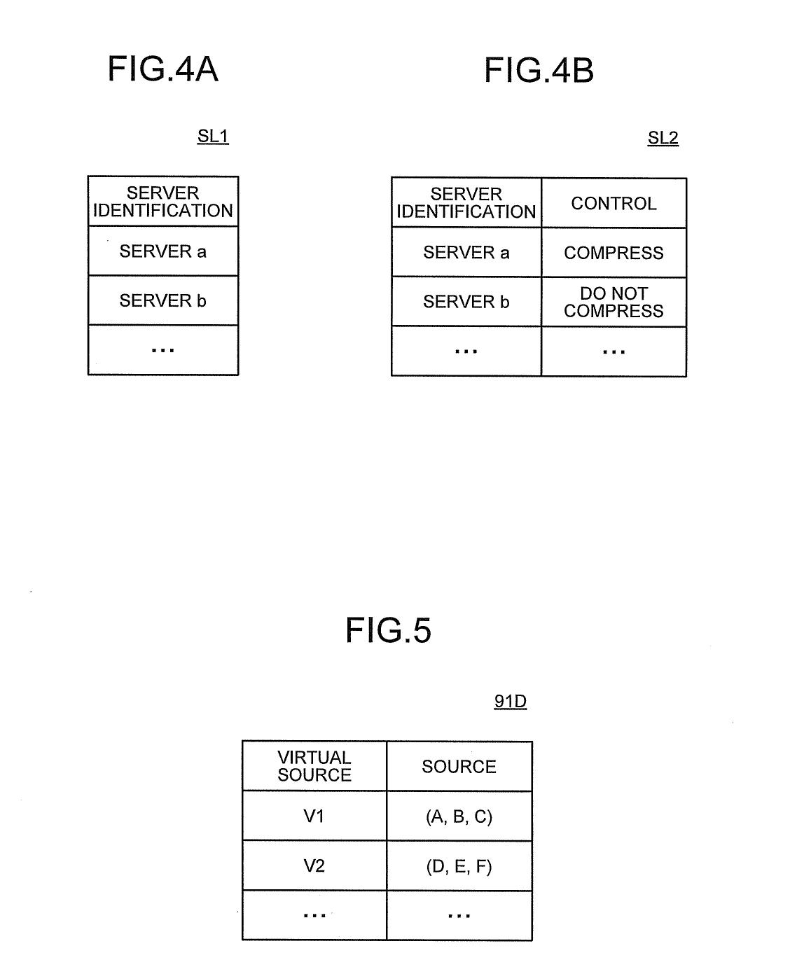

Explained is how destinations of communication packets that are to be compressed are managed. FIGS. 4A and 4B are diagrams illustrating exemplary data of server lists SL1 and SL2 (hereinafter, collectively referred to as “server lists SL”) according to the embodiment. As illustrated in FIGS. 4A and 4B, used in this embodiment is a server list SL to which one or more servers 200 can be registered in advance as destinations for which a communication packet is compressed and transmitted.

FIG. 4A illustrates exemplary data of the server list SL1 including entries of server identifier (destination identifier). The server identifier entry is an entry registered with server identification information for identifying a server 200 (destination identification information), and examples of the value registered to this entry include a server name, an internet protocol (IP) address, a port number, or a combination thereof. FIG. 4B illustrates exemplary data of the server list SL2 including entries of server identifier and control level. The control level is an entry registered with control information indicating whether the corresponding server 200 is to be handled as a destination of the communication packets to be compressed, and examples of the value registered include a value representing to compress or not to compress. These entries are registered in advance, by an administrator or the like, via a predetermined user interface (UI), for example. The SDN controller 70 manages the server list SL containing the servers 200 registered as the destinations of communication packets to be compressed.

Let us go back to the description of FIG. 3. The determining unit 12 refers to the server list SL acquired from the SDN controller 70, using the server identification information (destination information) of the server 200 defined as the destination in the communication packet, and determines whether the server 200 corresponding to the destination is registered in the server list SL (whether the destination is a registered server). As a result, if the server 200 corresponding to the destination defined in the communication packet is registered in the server list SL (if the destination is a registered server), the determining unit 12 determines that the communication packet is to be compressed. When the server list SL2 illustrated in FIG. 4B is referred to, the determining unit 12 refers to the control information corresponding to the server identification information of the matching server 200, and determines that the communication packet is to be compressed when the control information represents to compress.

The temporary storage unit 13 temporarily stores (retains) therein communication packets traversing the communication device 100. The temporary storage unit 13 corresponds to, for example, a predetermined storage area in a storage device provided to the communication device 100, and is an area in which the communication packets received within a predetermined time period are buffered. The communication packets received within the predetermined time period are stored and retained (buffered) by the determining unit 12 in the temporary storage unit 13. Because the communication packets received within the predetermined time period are temporarily stored, it can be said that the predetermined time period is equivalent to the time period for which the communication packets are temporarily stored (hereinafter, referred to as “retaining time period”). In other words, the temporary storage unit 13 retains the communication packets transferring for the predetermined time period. In the explanation hereafter, the predetermined time period is referred to as a slot.

The analyzing unit 14 analyzes the communication packets traversing the communication device 100. The analyzing unit 14 analyzes a process request defined in each of the communication packets stored in the temporary storage unit 13 (the communication packets received within the slot). The analyzing unit 14 then determines whether there are communication packets with similar process requests (hereinafter, referred to as “similar packets”), among those stored in the temporary storage unit 13, based on the result of analysis. For example, the analyzing unit 14 determines whether there are any communication packets with the same destination based on the analysis result of the destination information defined in the communication packets. As a result, if there are similar packets, the analyzing unit 14 acquires the communication packets corresponding to the similar packets from the temporary storage unit 13, and passes the communication packets to the compressing unit 15, instructing the compressing unit 15 to compress the communication packets. If there are no similar packets, the analyzing unit 14 acquires the analyzed communication packets from the temporary storage unit 13, and passes the communication packets to the communicating unit 16, instructing the communicating unit 16 to transmit the communication packets. When there are similar packets, the communication packets that are not the similar packets are passed to the communicating unit 16, in the same manner as when there are no similar packets.

The compressing unit 15 compresses the communication packets traversing the communication device 100. For example, the compressing unit 15 collectively compresses the communication packets received as the similar packets from the analyzing unit 14 into one packet. When the compressing unit 15 receives a plurality of communication packets addressed to the same destination, for example, the compressing unit 15 generates one communication packet for all of these communication packets, by setting the same destination information shared among all of these communication packets to the one communication packet. The compressing unit 15 also singularizes the different sources that are defined in a plurality of respective communication packets in the following manner. The compressing unit 15 issues a piece of information tentatively representing a source (virtual source) (hereinafter, referred to as “virtual source information”), and associates the issued virtual source information with the information of the different sources defined in the respective communication packets. The compressing unit 15 then stores the associated information in the decompression information storage unit 91, as the decompression information used in decompressing the communication packets. In this manner, the compressing unit 15 unifies the sources and the destinations respectively among a plurality of communication packets, and generates one communication packet by collecting the communication packets. The compressing unit 15 then passes the generated compressed communication packet to the communicating unit 16, and instructs the communicating unit 16 to transmit the communication packet.

The decompression information storage unit 91 stores therein decompression information registered (updated) by the compressing unit 15. The decompression information storage unit 91 corresponds to a predetermined storage area in the storage device provided to the communication device 100, for example, and stores therein decompression information with the following data structure, for example.

FIG. 5 is a diagram illustrating exemplary data of decompression information 91D according to the embodiment. FIG. 5 illustrates exemplary data of the decompression information 91D including entries of virtual source and source. The virtual source is an entry registered with virtual source information having been issued, and an example of the value registered to this entry includes a unique value issued for the compressed communication packet. The source is an entry registered with source information defined in the communication packet (actual source information), and an example of the value registered to this entry includes a value for identifying the client having transmitted the communication packet (e.g., a client name or an IP address). These values are associated with the respective information entries, and registered by the compressing unit 15. At this time, the source entry is registered with a plurality of pieces of different source information defined in the respective communication packet to be compressed.

The communicating unit 16 transmits communication packets. The communicating unit 16 transfers the communication packets traversing the communication device 100 from the source to the destination, based on the destination information defined in the communication packet. The communicating unit 16 transfers the communication packet received from one of the functional units including the analyzing unit 14, the compressing unit 15, and the decompressing unit 17, from the source to the destination. At this time, a communication packet received from one of the functional units including the analyzing unit 14 and the compressing unit 15 is transmitted to the server 200 processing the request. A communication packet received from the decompressing unit 17 is transmitted to the destination of the process response (client).

The decompressing unit 17 decompresses the communication packets traversing the communication device 100. The decompressing unit 17 receives a communication packet that is determined to be decompressed by the determining unit 12, and that includes the result of the process having been requested. If the destination of the traversing communication packet is not registered in the server list SL (if the destination is a non-registered server), the determining unit 12 determines whether the communication packet is to be decompressed in the following manner. The determining unit 12 checks for the source of the communication packet, based on the source information defined in the communication packet acquired by the input unit 11. If the source of the communication packet is a virtual source issued at the time when the corresponding communication packets are compressed, the determining unit 12 determines that the communication packet is to be decompressed.

The decompressing unit 17 decompresses the communication packet determined as described above. The decompressing unit 17 refers to the decompression information 91D stored in the decompression information storage unit 91, and decompresses the communication packet including the result of the process in the following manner. That is, the decompressing unit 17 refers to the decompression information 91D using the virtual source information defined in the communication packet, and identifies the source entry corresponding to the virtual source entry. The decompressing unit 17 then acquires a plurality of pieces of source information registered in the identified source entry as the destination information of the decompressed communication packets. In other words, the decompressing unit 17 uses the actual sources registered to be associated with the virtual source in the decompression information 91D, as the destinations of the respective communication packets to which the results of the process are to be transmitted. In this manner, the decompressing unit 17 decompresses the communication packet received from the determining unit 12 into a plurality of communication packets including the result of the process and corresponding to the respective actual destinations. At this time, the decompressing unit 17 generates, for each of the destinations, a communication packet including the destination, the source, and the result of the process, based on the acquired pieces of destination information. The decompressing unit 17 then passes the generated decompressed communication packets to the communicating unit 16, and instructs the communicating unit 16 to transmit the communication packets. A communication packet defined with a source that is not a virtual source is passed through the decompressing unit 17 to the communicating unit 16, without causing the decompressing unit 17 to decompress.

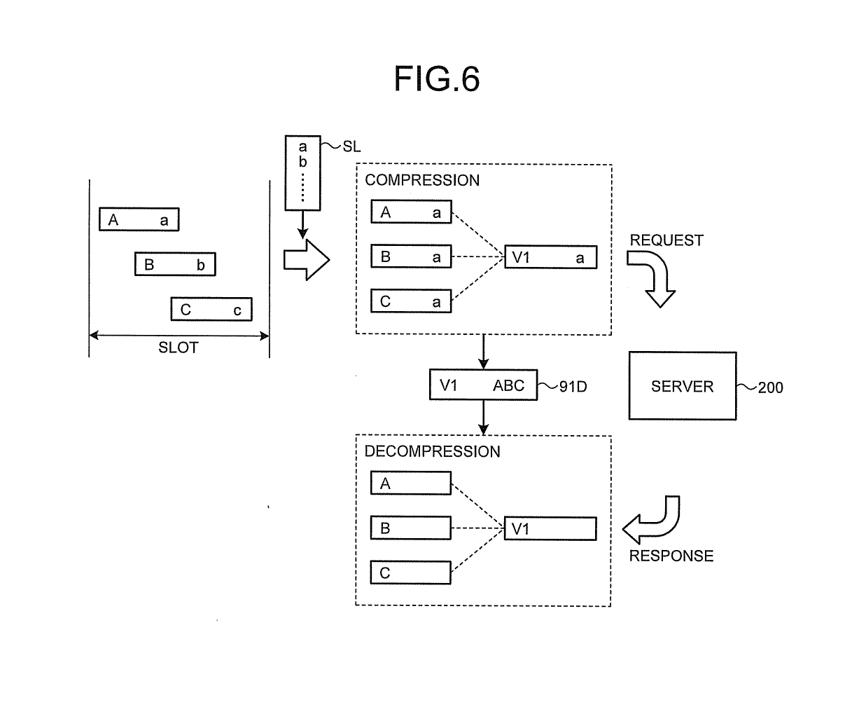

In the communication device 100 according to the embodiment, the functional units described above cooperate with one another to implement the following operation. FIG. 6 is a diagram illustrating an exemplary operation performed by the communication device 100 according to the embodiment. Illustrated in FIG. 6 is an exemplary operation when sources “A”, “B”, and “C” transmit respective three communication packets to a destination “a” corresponding to the server 200 that processes their requests.

To begin with, the communication device 100 according to the embodiment causes the determining unit 12 to determine whether the three, traversing communication packets are to be compressed. The determining unit 12 determines that the communication packets are to be compressed if the destinations of these communication packets received within the slot are registered in the server list SL, and stores the communication packets in the temporary storage unit 13.

If the stored communication packets include any similar packets with the same destination “a” based on the result of analysis performed by the analyzing unit 14, the communication device 100 then causes the compressing unit 15 to compress the communication packets corresponding to the similar packets. At this time, the compressing unit 15 issues a virtual source V1 to the different sources “A”, “B”, and “C” defined in the respective communication packets, and generates a communication packet defined with the issued virtual source V1 and the same destination “a” that is shared among the communication packets, as a compressed communication packet. The compressing unit 15 also registers the issued virtual source V1 associated with the actual destinations “A”, “B”, and “C” of the respective communication packets, as the decompression information 91D.

The communication device 100 then causes the communicating unit 16 to transmit the compressed communication packet to the server 200 that is the destination “a”, and requests the process. As a result, the server 200 performs the requested process, transmits the communication packet including the result of the process to the communication device 100, as a response to the process request.

Upon receiving the response, the communication device 100 causes the determining unit 12 to determine whether the traversing communication packet is to be decompressed. If the source of the communication packet is a virtual source, the determining unit 12 determines that the communication packet is to be decompressed, and instructs the decompressing unit 17 to decompress the communication packet. As a result, the decompressing unit 17 in the communication device 100 refers to the decompression information 91D, and decompresses the communication packet including the result of the process into three communication packets that are defined with the respective sources “A”, “B”, and “C”, which are registered to be associated with the virtual source V1, as the respective destinations, and include the result of the process.

The communication device 100 then causes the communicating unit 16 to transmit the decompressed three communication packets to the respective destinations “A”, “B”, and “C”, as a response to the process request.

A process performed by the communication device 100 according to the embodiment in order to implement the operation described above will now be explained.

Process performed by Communication Device 100

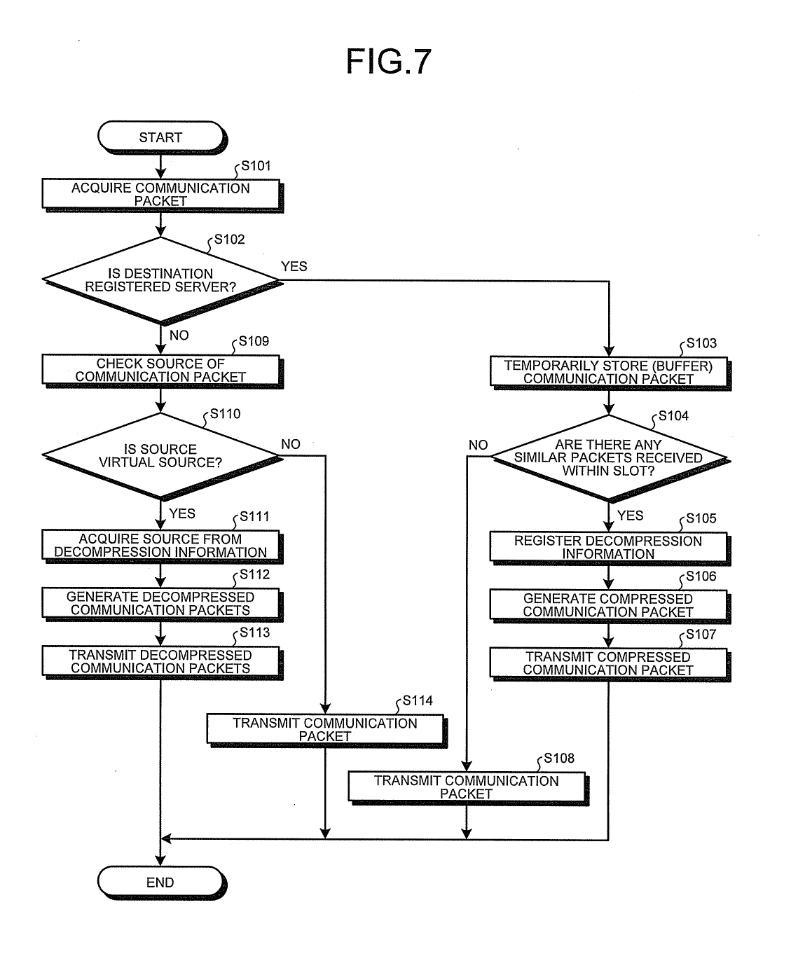

FIG. 7 is a flowchart illustrating an exemplary process performed by the communication device 100 according to the embodiment. As illustrated in FIG. 7, to begin with, the communication device 100 according to the embodiment causes the input unit 11 to acquire a traversing communication packet (Step S101).

The determining unit 12 determines whether the destination of the acquired communication packet is a server registered in the server list SL (Step S102). At this time, the determining unit 12 refers to the server list SL acquired from the SDN controller 70 using the destination information defined in the communication packet, and determines whether the server 200 corresponding to the destination is registered in the server list SL.

As a result, if the determining unit 12 determines that the destination is a registered server (Yes at Step S102), the determining unit 12 determines that the communication packet is to be compressed. The determining unit 12 then stores the corresponding communication packets received within the slot in the temporary storage unit 13 (Step S103).

In response, the analyzing unit 14 analyzes the communication packets stored in the temporary storage unit 13, and determines whether there are any similar packets with similar process requests, among those received within the slot, based on the result of the analysis (Step S104). In this embodiment, the analyzing unit 14 determines whether there are any communication packets with the same destination, among those received within the slot.

As a result, if the analyzing unit 14 determines that there are similar packets in the slot (Yes at Step S104), the analyzing unit 14 passes the communication packets corresponding to the similar packets to the compressing unit 15, and instructs the compressing unit 15 to compress the communication packets.

In response, the compressing unit 15 registers the decompression information 91D for the received communication packets to the decompression information storage unit 91 (Step S105). At this time, the compressing unit 15 issues virtual source information for unifying the different pieces of source information defined in the respective communication packets, and registers the issued virtual source information in the decompression information 91D associated with the different pieces of source information defined in the respective communication packets.

The compressing unit 15 then generates a compressed communication packet that is a unification of received communication packets (Step S106). At this time, the compressing unit 15 generates one communication packet defined with the issued virtual source information and the same destination information shared among the communication packets, passes the compressed communication packet to the communicating unit 16, and instructs the communicating unit 16 to transmit the communication packet.

In response, the communicating unit 16 transmits the received compressed communication packet to the server 200 corresponding to the destination (Step S107).

If the analyzing unit 14 determines that there are no similar packets in the slot (No at Step S104), the analyzing unit 14 passes the communication packets that are not the similar packets to the communicating unit 16 as they are, and instructs the communicating unit 16 to transmit the communication packets.

Upon receiving the packets, the communicating unit 16 transmits the received communication packets to the server 200 corresponding to their respective destinations (Step S108).

If the determining unit 12 determines that the destination is a server not registered in the server list SL (No at Step S102), the determining unit 12 determines that the communication packet is not to be compressed, and checks for the source of the communication packet (Step S109). At this time, the determining unit 12 checks for the source of the communication packet based on the source information defined in the communication packet.

The determining unit 12 then determines whether the source is a virtual source (Step S110). At this time, the determining unit 12 determines whether the source information defined in the communication packet is the virtual source information issued at the time when the corresponding communication packets are compressed.

As a result, if the determining unit 12 determines that the source is a virtual source (Yes at Step S110), the determining unit 12 determines that the communication packet is to be decompressed, passes the corresponding communication packet to the decompressing unit 17, and instructs the decompressing unit 17 to decompress the communication packet.

In response to the instruction, the decompressing unit 17 acquires the destinations from the decompression information 91D (Step S111). At this time, the decompressing unit 17 refers to the decompression information 91D stored in the decompression information storage unit 91, and acquires the pieces of source information registered to be associated with the virtual source information that is defined in the received communication packet, as the destination information of the decompressed communication packets.

The decompressing unit 17 then generates the decompressed communication packets from the received communication packet (Step S112). At this time, the decompressing unit 17 generates a plurality of communication packets that are defined with the source information that is defined in the communication packet, and with the respective pieces of the acquired destination information. The decompressing unit 17 then passes the decompressed communication packets to the communicating unit 16, and instructs the communicating unit 16 to transmit the communication packets.

Upon receiving the instruction, the communicating unit 16 transmits the received decompressed communication packets to the clients corresponding to the respective destinations (Step S113).

If the determining unit 12 determines that the source is not a virtual source (No at Step S110), the determining unit 12 determines that the communication packet is not to be decompressed, and passes the communication packet defined with a source that is not a virtual source to the communicating unit 16 as it is, and instructs the communicating unit 16 to transmit the communication packet.

Upon receiving the instruction, the communicating unit 16 transmits the received communication packet to the client corresponding to the destination (Step S114).

Summary

As described above, the communication device 100 according to the embodiment temporarily stores therein the received communication packets. The communication device 100 according to the embodiment then determines whether there are any similar packets based on the analysis result of the communication packets temporarily stored, the analysis being performed by the analyzing unit 14. If there are any similar packets, the communication device 100 according to the embodiment causes the compressing unit 15 to compress the communication packets corresponding to the similar packets into one communication packet, and causes the communicating unit 16 to transmit the compressed communication packet to the server 200 that is the addressee of the process request.

Through this process, the communication device 100 according to the embodiment provides an environment in which the communication packets with similar process requests are compressed, and the compressed communication packet is transmitted to the server 200 that is the addressee of the process request, for a network service providing a static content such as a storage service. As a result, the communication device 100 according to the embodiment can alleviate the load of both of the servers 200 and the communication path to the servers 200. Therefore, with the communication device 100 according to the embodiment, the IO performance of a cloud infrastructure providing high density network services with a virtual appliance 80 can be improved.

Explained in the embodiment described above is an example of the data (FIG. 4B) of the server list SL2 including the control information presenting a value representing to compress or not to compress, but the server list SL2 is not limited thereto. For example, the control information may be a value representing a compression format.

### Second Embodiment

Overview

A function (communication function) provided to the communication device according to a second embodiment will be explained. The communication device according to the embodiment adjusts the time period (slot width) for which the communication packets are retained depending on how the server processing the request or the communication path to the server is congested with the communication packets.

Functional configuration and an operation of the communication device according to the embodiment will now be explained. In the explanation hereafter, differences with the embodiment described above will be explained, the same elements are denoted by the same reference numerals, and the explanations thereof are omitted herein.

Functions of Communication Device 100

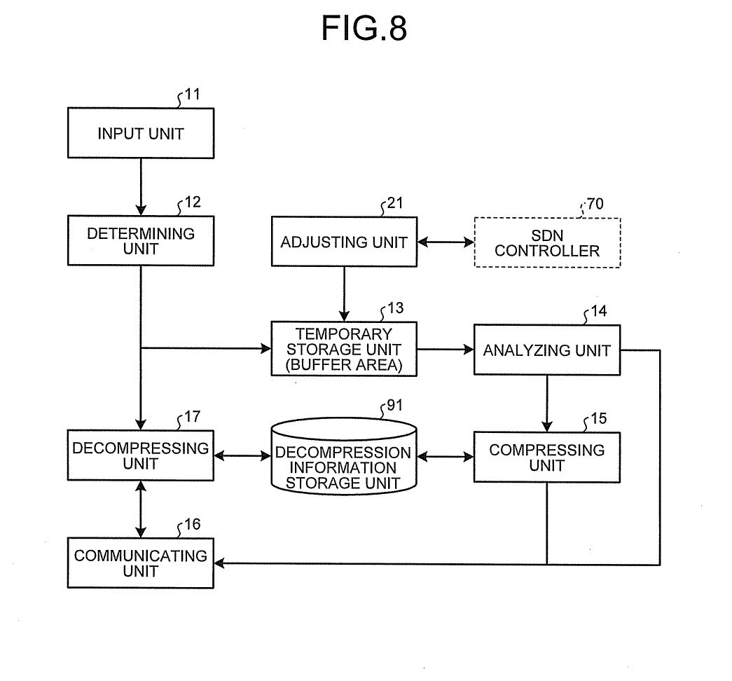

FIG. 8 is a diagram illustrating an exemplary functional configuration of the communication device 100 according to the embodiment. As illustrated in FIG. 8, the communication device 100 according to a second embodiment includes an adjusting unit 21, in addition to the functional configuration of the communication device 100 according to the first embodiment.

The adjusting unit 21 adjusts the time period (slot width) for which the communication packets are retained in the temporary storage unit 13 depending on the congestion level of communication packets (hereinafter, referred to as a “congestion level”). For example, the adjusting unit 21 acquires a measurement result of a congestion level of communication packets (e.g., “a measurement value of communication load”) from the SDN controller 70, and adjusts the time period (slot width) for which the communication packets are retained based on the acquired measurement result.

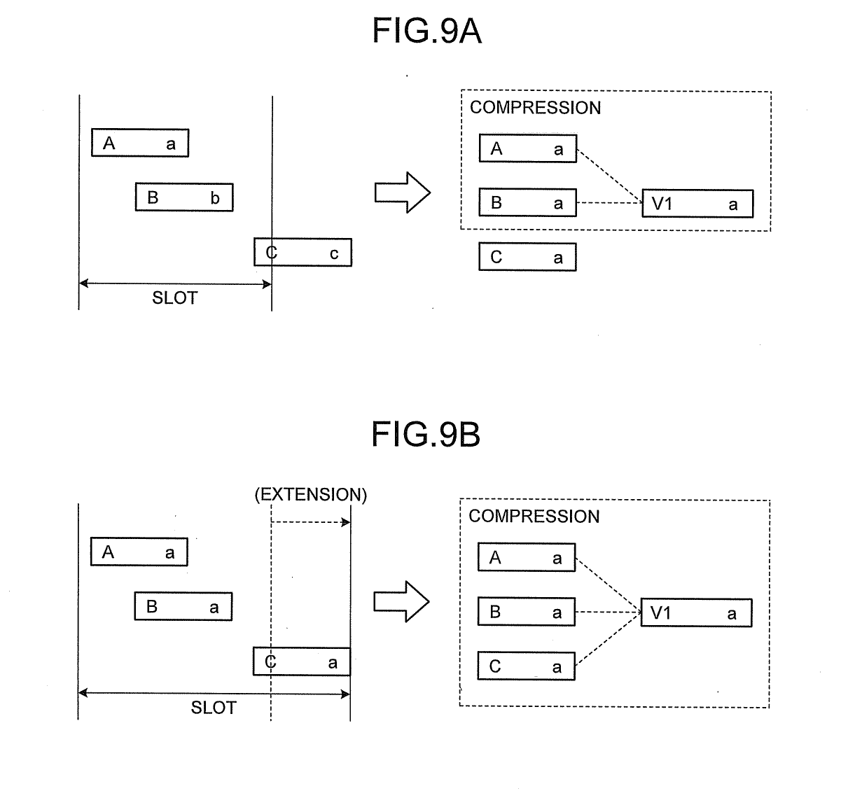

FIGS. 9A and 9B are diagrams illustrating comparative examples of operations with and without some similar packets arriving within the same slot. For example, FIG. 9A illustrates an example in which two of the three communication packets with the same destination “a” (similar packets), two being those from the sources “A” and “B”, respectively, arrive within the same slot. A delay is a possible cause having prevented the communication packet from the source “C” from arriving within the same slot as those from the sources “A” and “B”, and a delay is affected by the congestion level of communication packets. In such a case, the two communication packets from the sources “A” and “B” are determined to be similar packets and compressed into one packet, but the communication packet from the source “C” is not compressed, so that the compression ratio is reduced.

To address this issue, the compression ratio is improved by extending the slot width so that the retaining time period for which the communication packets are temporarily stored is extended. For example, FIG. 9B illustrates an example in which the slot width is extended so that the three communication packets with the same destination “a” are received within the same slot, including the communication packet from the source “C” arriving with some delay. In this example, the three communication packets from the respective sources “A”, “B”, and “C” are determined as similar packets and collectively compressed into one packet. As a result, the compression ratio is improved.

The responses to the process requested by the communication packets, however, are somewhat delayed because the slot width is extended so that the communication packets are temporarily stored for a longer retaining time period (the response speed deteriorates). Furthermore, because a larger number of communication packets are temporarily stored, a larger memory capacity (buffer area) is required in the temporary storage unit 13. In this manner, if the slot width is extended so that the retaining time period for which the communication packets temporarily stored is extended, these issues need to be addressed.

In response to these issues, in this embodiment, focusing on the fact that the compression efficiency of communication packets is dependent on the time period (slot width) for which the communication packet are retained in the temporary storage unit 13, and also on the average arrival ratio of the communication packets arriving within the same slot, the communication device 100 makes the following adjustment.

When the adjusting unit 21 determines that there is some extra communication bandwidth available based on a measurement result of the congestion level of communication packets, the adjusting unit 21 makes the adjustment to shorten the retaining time period (slot width) so that the response speed is prioritized over the compression efficiency. By contrast, when the adjusting unit 21 determines that there is no extra communication bandwidth available, the adjusting unit 21 makes the adjustment to extend the retaining time period (slot width) so that the compression efficiency is prioritized over the response speed. The adjusting unit 21 may determine the availability of the extra communication bandwidth in the following manner, as an example. The adjusting unit 21 may compare the measurement result of congestion level with a predefined threshold, and determine that there is no extra communication bandwidth available if the measurement result of congestion level is equal to or higher than the threshold, and determine that there is some extra communication bandwidth available if the measurement result of congestion is lower than the threshold. Examples of the threshold includes a determination reference that is calculated from some statistics related to the communication load, or a determination reference that is specified by an administrator based on a condition of the communication load, for example.

In the manner described above, this embodiment is not merely intended to extend the slot width to a predetermined width so that the retaining time period for which the communication packets temporarily stored is extended. In this embodiment, by contrast, the communication device 100 determines which one of the compression efficiency and the response speed is prioritized based on the congestion level of communication packets (the condition of the communication load), and adjusts the time period (slot width) for which the communication packets are retained accordingly.

A process performed by the adjusting unit 21 according to the embodiment in order to implement the operation described above will now be explained.

Process Performed by Adjusting Unit 21

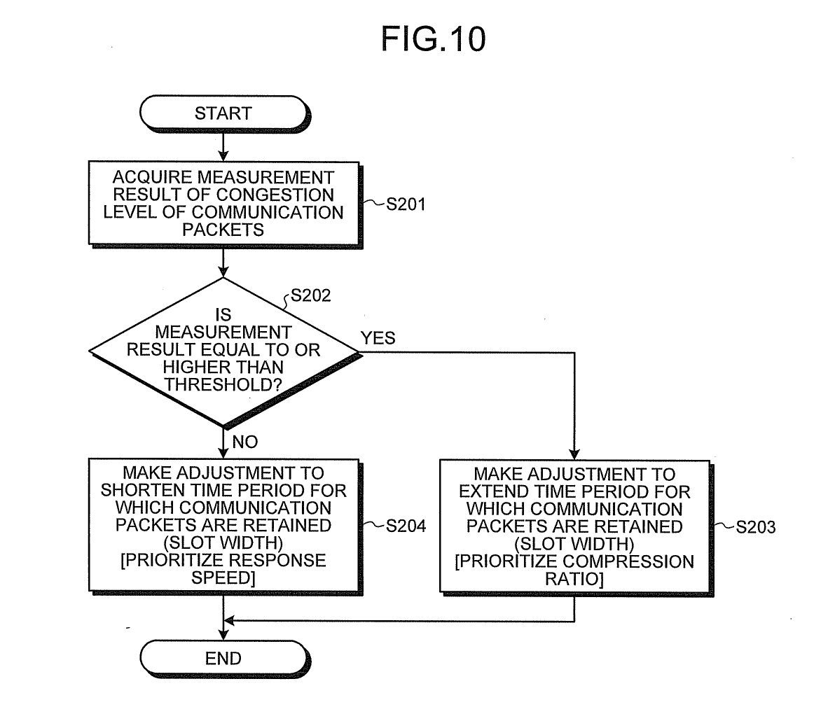

FIG. 10 is a flowchart illustrating an exemplary process performed by the adjusting unit 21 according to the embodiment. As illustrated in FIG. 10, the adjusting unit 21 according to the embodiment acquires a measurement result of congestion level of communication packets (Step S201). At this time, the adjusting unit 21 acquires a measurement result of congestion level of communication packets from the SDN controller 70. The adjusting unit 21 may acquire the measurement result of congestion level passively or actively. If the measurement result is acquired passively, the adjusting unit 21 may receive a measurement result notified (fed back) by the SDN controller 70 once in every predetermined time period. If the measurement result is acquired actively, the adjusting unit 21 may request the measurement result from the SDN controller 70 once in every predetermined time period, for example.

The adjusting unit 21 then determines whether the acquired measurement result is equal to or higher than the threshold (Step S202).

As a result, if the adjusting unit 21 determines that the measurement result is equal to or higher than the threshold (Yes at Step S202), the adjusting unit 21 determines that there is no extra communication bandwidth available, and makes an adjustment to increase (extend) the time period (slot width) for which communication packets are retained in the temporary storage unit 13 (Step S203). In other words, if there is no extra communication bandwidth available, the adjusting unit 21 makes an adjustment to prioritize the compression efficiency over the response speed. At this time, the adjusting unit 21 makes this adjustment by setting a larger value than the current value, to a control value for controlling the length of the time period (slot width) for which communication packets are retained in the temporary storage unit 13.

If the measurement result is lower than the threshold (No at Step S202), the adjusting unit 21 determines there is some extra communication bandwidth available, and makes an adjustment to reduce (shorten) the time period (slot width) for which communication packets are retained in the temporary storage unit 13 (Step S204). In other words, if there is some extra communication bandwidth available, the adjusting unit 21 makes an adjustment to prioritize the response speed over the compression efficiency. At this time, the adjusting unit 21 makes this adjustment by setting a smaller value than the current value to the control value for controlling the length of the time period (slot width) for which communication packets are retained in the temporary storage unit 13.

Summary

As described above, the communication device 100 according to the embodiment temporarily stores therein the received communication packets. The communication device 100 temporarily stores the received communication packets based on the retaining time period (slot width) adjusted by the adjusting unit 21 in response to a congestion level of the communication packets. The communication device 100 according to the embodiment then causes the analyzing unit 14 to determine whether there are any similar packets based on the result of analyzing the communication packet temporarily stored. If there are any similar packets, the communication device 100 according to the embodiment causes the compressing unit 15 to collectively compress the communication packets corresponding to the similar packets into one communication packet, and causes the communicating unit 16 to transmit the compressed communication packet to the server 200 that is the addressee of the process request.

As a result, the communication device 100 according to the embodiment can alleviate the load of both of the server 200 and the communication path to the server 200, in the same manner as in the first embodiment. Furthermore, the communication device 100 according to the embodiment enables the services to be provided at high quality by adjusting the time period (slot width) for which the communication packets are retained based on the congestion level of communication packets so that both of the compression efficiency of the similar packet and the response speed to the process request are taken into consideration.

First Modification

Overview

Proposed as a first modification is a method for improving the compression efficiency by adjusting the time period (slot width) for which the communication packets are retained so that the similar communication packets (similar packets) are received within the same slot. In a streaming distribution service such as a video content distribution service, a plurality of different clients request distribution process of the same video content from the server. When the communication packets received from different destinations (clients) are similar packets, as mentioned above, it is preferable, from the viewpoint of the compression efficiency, for such communication packets to be received within the same slot. Such communication packets are however transmitted from the respective sources at different timing. To address this issue, in the first modification, the communication packet arriving earlier in the same slot is delayed by causing the adjusting unit to adjust the time period (slot width) for which the communication packet is retained so as to synchronize the communication of the communication packets and to allow the similar packets to be received within the same slot. This adjustment is intended to improve the compression efficiency. In other words, in the first modification, the compression efficiency is improved by reducing the time lag between the similar packets arriving within a slot.

The functional units and the operation of the communication device according to the first modification will be explained. In the explanation hereafter, differences with the embodiment described above will be explained, the same elements are denoted by the same reference numerals, and the explanations thereof are omitted.

Functions of Communication Device 100

The adjusting unit 21 adjusts the time period (slot width) for which the communication packets are retained based on traffic conditions of the actual communication packets. The adjusting unit 21 analyzes a communication pattern of the similar packets based on the traffic conditions of communication packets, and adjusts the time period (slot width) for which the communication packets are retained based on the analysis result. The communication pattern corresponds to a pattern of timing at which the similar packets are received within the slot (the timing of transferring of similar packets).

To begin with, the adjusting unit 21 analyzes the communication pattern of the similar packets based on the traffic conditions of the communication packets within the slot. The adjusting unit 21 records the traffic conditions of the communication packets within the slot in the following manner. The adjusting unit 21 calculates a hash value for information of a combination of the content of each communication packet received within the slot and the time of transferring. The adjusting unit 21 then retains the calculated hash value (calculated value) in the chronological order of transferring of the communication packets, and records the hash values representing the traffic conditions of the communication packets.

The adjusting unit 21 then analyzes whether there is any pattern in the timing at which the similar packets have arrived within the slot, based on the hash values (calculated values) recorded as described above, and adjusts the time period (slot width) for retaining the communication packets so that the similar packets are received within the same slot, based on the result of the analysis. The adjusting unit 21 then adjusts the retaining time period (slot width) based on the amount of similar packets recorded at the transferring of communication packets, for example, and a communication packet arriving earlier within the slot is delayed.

As described above, the communication device according to the first modification analyzes the communication pattern of the similar packets based on traffic conditions of the communication packets, and adjusts the time period (slot width) for which the communication packets are retained based on the analysis result so that the similar packets are received within the same slot.

A process performed by the adjusting unit 21 according to the embodiment in order to implement the operation described above will be explained.

Process Performed by Adjusting Unit 21

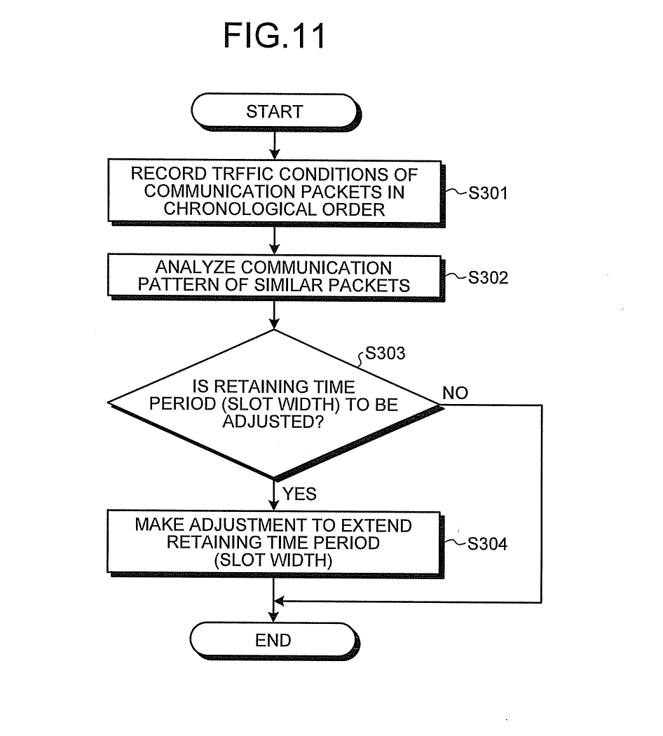

FIG. 11 is a flowchart illustrating an exemplary process performed by the adjusting unit 21 according to the first modification. As illustrated in FIG. 11, the adjusting unit 21 according to the embodiment records the traffic conditions of communication packets within the slot (Step S301). At this time, the adjusting unit 21 calculates a hash value representing the information including the content of each communication packet having transferred within the slot and the time of transferring, retains the calculated hash value in the chronological order, and records the hash values as a record of the traffic conditions of the communication packets.

The adjusting unit 21 then analyzes the communication pattern of the similar packets based on the record of the traffic conditions of communication packets (Step S302). At this time, the adjusting unit 21 analyzes the communication pattern of the similar packets based on the hash values recorded in the chronological order.

The adjusting unit 21 then determines whether to adjust the time period (slot width) for which the communication packets are retained (Step S303). At this time, the adjusting unit 21 determines whether a communication packet arriving earlier within the slot should be delayed so that the similar packets are received within the same slot, based on the result of analyzing the communication pattern of the similar packets.

As a result, if the adjusting unit 21 determines that the retaining time period (slot width) should be adjusted (Yes at Step S303), the adjusting unit 21 makes an adjustment to extend the time period (slot width) for which communication packets are retained in the temporary storage unit 13 (Step S304). At this time, the adjusting unit 21 makes the adjustment by setting a larger value larger than the current value to the control value for controlling the length of the time period (slot width) for which communication packets are retained in the temporary storage unit 13.

If the adjusting unit 21 determines that the retaining time period (slot width) should not be adjusted (No at Step S303), the adjusting unit 21 does not adjust the time period (slot width) for which communication packets are retained in the temporary storage unit 13.

Summary

As described above, the communication device 100 according to the first modification temporarily stores (buffers) the received communication packets. At this time, the communication device 100 temporarily stores the received communication packets in accordance with the retaining time period (slot width) adjusted by the adjusting unit 21 so that the similar packets are received within the same slot, based on the communication pattern of the communication packets having similar process requests (similar packets) within the slot. The communication device 100 according to the first modification then determines whether there are any similar packets based on the analysis result of the communication packet temporarily stored, the analysis being performed by the analyzing unit 14. If there are any similar packets, the communication device 100 according to the first modification causes the compressing unit 15 to collectively compress the communication packets corresponding to the similar packets into one communication packet, and causes the communicating unit 16 to transmit the compressed communication packet to the server 200 that is the addressee of the process request.

As a result, the communication device 100 according to the first modification can improve the compression efficiency of the similar packets received from different sources (clients), by reducing the time lag between the similar packets arriving within the slot, in addition to the same advantageous effects as those in the embodiment described above. The communication device 100 according to the first modification, therefore, enables services such as a streaming distribution service to be provided at high quality.

Second Modification

Overview

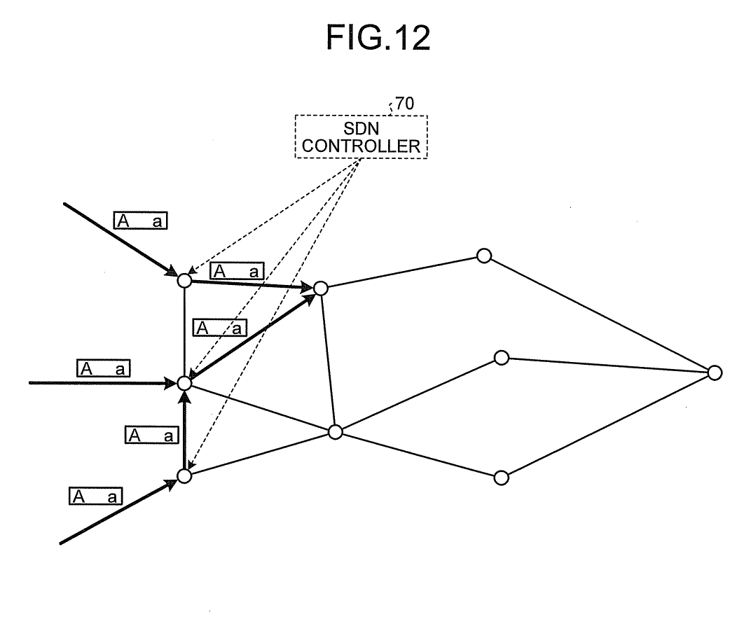

FIG. 12 is a schematic diagram generally illustrating a communication control function according to the second modification. Illustrated in FIG. 12 is an example in which communication packets with matching source “A” and destination “a” are transferred via the same transfer point (the same node). In the second modification, the SDN controller 70 controls communication (routes the communication packets) by controlling the communication device deployed at each transfer point (node) so that the matching communication packets are transferred via the same transfer point. This is intended to improve the compression efficiency by collecting the matching communication packets to the same one communication device.

The functional configuration and the operation of the communication device according to the second modification will be explained. In the explanation hereafter, differences with the embodiment described above will be explained, the same elements are denoted by the same reference numerals, and the explanations thereof are omitted.

Functions of Communication Device 100

In the second modification, the SDN controller 70 controls the communicating unit 16 included in the communication device 100 so that the matching communication packets are transferred via the same transfer point. The SDN controller 70 therefore corresponds to a communication control unit.

The communicating unit 16 determines a transfer point (next node) for a communication packet received from the other functional units such as the analyzing unit 14, the compressing unit 15, and the decompressing unit 17. To begin with, if the communication packet is a communication packet received for the first time, the communicating unit 16 calculates a hash value for information of a combination of the destination of and the content of the communication packet. The communicating unit 16 then stores the calculated hash value (calculated value) associated with the communication packet, and passes the hash value to the SDN controller 70, requesting the SDN controller 70 to determine the next transfer point (next node) of the communication packet.

The SDN controller 70 classifies the received hash values (calculated values) within a range of predetermined communication paths including a plurality of adjacent transfer points (a plurality of adjacent nodes), for example. The SDN controller 70 is then allowed to identify a communication path based on the classified hash value, and determines the next transfer point (next node) based on the determined communication path.

The communicating unit 16 then transmits the communication packet to the transfer point (next node) determined by the SDN controller 70.

As described above, the communication device 100 according to the second modification classifies a communication packet based on the destination and the content of the communication packet, determines the next transfer point (next node) from the communication path identified with the classification result, and transmits the communication packet to the determined transfer point (node).

A process performed by the communicating unit 16 according to the embodiment in order to implement the operation described above will be explained.

Process Performed by Communicating Unit 16

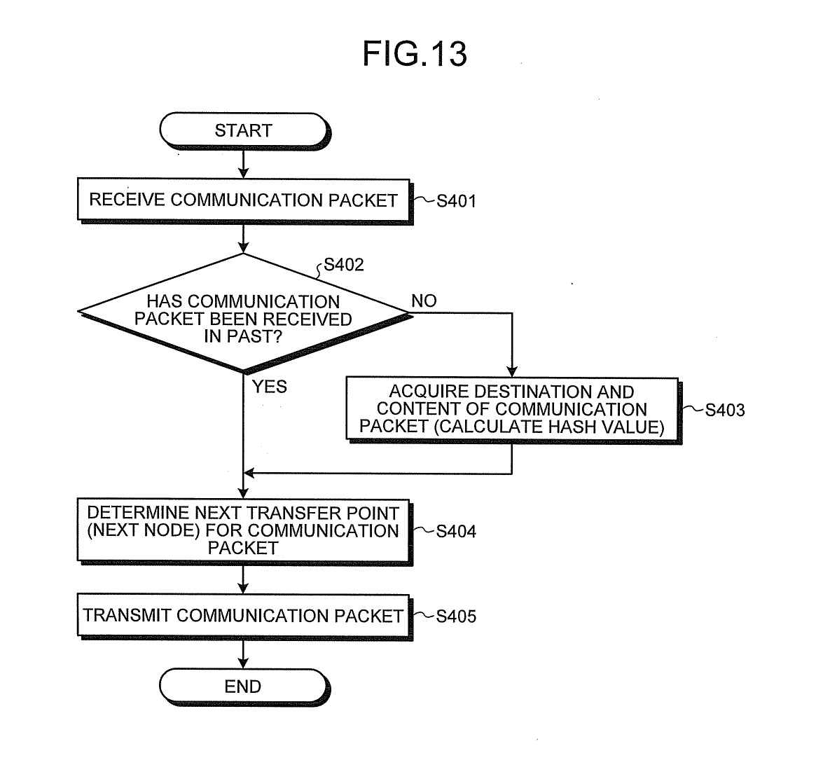

FIG. 13 is a flowchart illustrating an exemplary process performed by the communicating unit 16 according to the second modification. As illustrated in FIG. 13, the communicating unit 16 according to the second modification receives a communication packet (Step S401).

The communicating unit 16 then determines whether the received communication packet is a communication packet having been received in the past (Step S402). At this time, the communicating unit 16 makes this determination based on the hash value representing the information including the destination and the content of the communication packet, calculated and stored when the communication packet is received for the first time.

As a result, if the communicating unit 16 determines that the received communication packet is not a communication packet having been received in the past (No at Step S402), the communicating unit 16 acquires the destination and the content of the communication packet (Step S403). The communicating unit 16 then calculates a hash value from the acquired information and stores the calculated hash value.

If the communicating unit 16 determines that the received communication packet is a communication packet having been received in the past (Yes at Step S402), the communicating unit 16 then determines the next transfer point (next node) for the communication packet (Step S404). At this time, the communicating unit 16 requests the SDN controller 70 to determine the next transfer point (next node) for the communication packet, based on the hash value corresponding to the communication packet.

The communicating unit 16 then transmits the communication packet to the determined transfer point (node) (Step S405).

Summary

As described above, the communication device 100 according to the second modification temporarily stores (buffers) received communication packets. The communication device 100 according to the second modification then determines whether there are communication packets with similar process requests (similar packet), based on the result of analyzing the communication packet temporarily stored by the analyzing unit. If there are any similar packets, the communication device 100 according to the second modification then causes the compressing unit 15 to collectively compress the communication packets corresponding to the similar packets into one communication packet. The communication device 100 according to the second modification then determines the next transfer point (next node) of the communication packet from the communication path determined by the communicating unit 16 based on the destination and the content of the communication packet, and transmits the communication packet to the determined transfer point (node).

As a result, the communication device 100 according to the second modification can collect the matching communication packets to the same transfer point (the same node), so that the compression efficiency can be further improved, in addition to the same advantageous effects as those in the embodiment described above.

Device

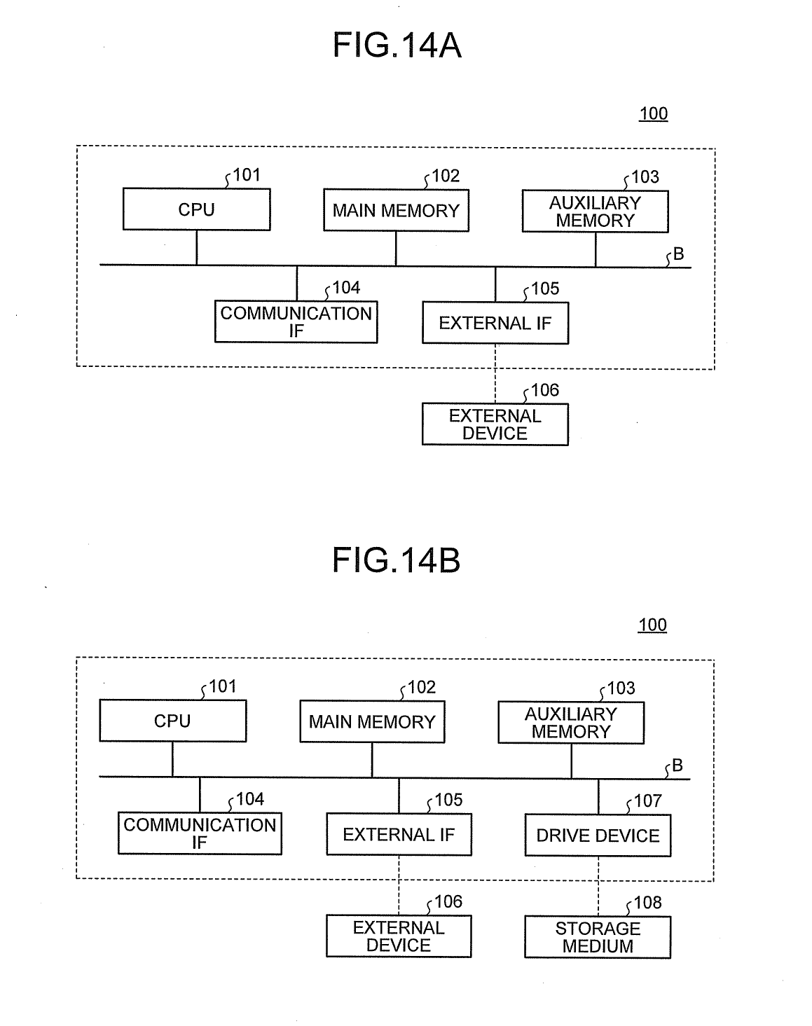

FIGS. 14A and 14B are diagrams illustrating exemplary configurations of the communication device 100 according to the embodiments. As illustrated in FIG. 14A, the communication device 100 according to the embodiments includes a central processing unit (CPU) 101 and a main memory 102. The communication device 100 also includes an auxiliary memory 103, a communication interface (IF) 104, and an external IF 105. In the communication device 100, each of these devices is connected to one another via a bus B.

The CPU 101 is a processor for implementing the control over the entire device and for implementing the functions of the device. The main memory 102 is a storage device (memory) for retaining computer programs, data, and the like in a predetermined memory area. Examples of the main memory 102 include a read-only memory (ROM) and a random access memory (RAM). The auxiliary memory 103 is a storage device provided with a storage area with a capacity larger than that of the main memory 102. The auxiliary memory 103 is a non-volatile storage device such as a hard disk drive (HDD) or a memory card. The CPU 101 implements the control over the entire device and the functions of the device by reading a computer program and data from the auxiliary memory 103 onto the main memory 102, and executing the corresponding process, for example.

The communication IF 104 is an interface for connecting the device to a communication circuit. This enables the communication device 100 to establish data communication with information processing devices such as other communication devices, clients, and the servers 200. The external IF 105 is an interface for exchanging data between the device and external devices 106. An example of the external device 106 includes a display device (e.g., a “liquid crystal display”) for displaying various type of information such as a result of a process.

The communication device 100 according to the embodiments may be a general information processing device as illustrated in FIG. 14B. In such a case, the communication device 100 also includes a drive device 107. The drive device 107 is a controller that performs writing to and reading from a storage medium 108. Examples of the storage medium 108 include a flexible disk (FD), a compact disc (CD), and digital versatile disc (DVD). An example of the external device 106 includes an input device for receiving an operation input (e.g., a “numeric keypad”, a “keyboard”, or a “touch panel”).

The communication function according to the embodiments is implemented by causing the communication device 100 to execute a computer program and by causing the functional units to operate cooperatively, for example. In such a configuration, the computer program is provided to be recorded in a storage medium that can be read by a device (computer) in an execution environment, as a file in an installable or executable format. When the communication device 100 is an information processing device, for example, the computer program has a modular structure including the functional units. By causing the CPU 101 to read the computer program from the storage medium 108 and to execute the computer program, these functional units are generated on the RAM in the main memory 102. The way in which the computer program is provided is not limited thereto. For example, the computer program may be stored in a storage device connected to the Internet, for example, and downloaded over a communication circuit. The computer program may also be provided in a manner incorporated in the ROM in the main memory 102 or the HDD in the auxiliary memory 103 in advance. Explained herein is an example in which the communication function is implemented as software, but the embodiment is not limited thereto. For example, the functional units of the communication function may be partly or entirely implemented as hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a determining unit that determines whether a received communication packet is to be compressed;
a storage unit that stores therein the communication packet determined to be compressed;
an analyzing unit that analyzes a plurality of stored communication packets, and determines whether the communication packets include any similar packets having similar process requests, based on a result of analysis;
a compressing unit that compresses the communication packets corresponding to the similar packets when the communication packets are determined to include some similar packets; and
a communicating unit that transmits the compressed communication packet.

2. The communication device according to claim 1, further comprising an adjusting unit that adjusts a time period for which the communication packet is stored in the storage unit, wherein
the adjusting unit adjusts the time period based on a congestion level of the communication packets.

3. The communication device according to claim 2, wherein the adjusting unit compares a measurement result of the congestion level with a preset threshold, extends the time period when the congestion level is equal to or higher than the threshold, and shortens the time period when the congestion level is lower than the threshold.

4. The communication device according to claim 2, wherein the adjusting unit adjusts the time period based on traffic conditions of the communication packets.

5. The communication device according to claim 4, wherein the adjusting unit records the traffic conditions of the communication packets, and analyzes for a regularity in timing at which the similar packets transfer, based on the recorded traffic conditions, and extends the time period based on a result of analysis.

6. The communication device according to claim 1, wherein the determining unit determines to compress the communication packet when a destination of the communication packet is a destination registered in advance.

7. The communication device according to claim 1, wherein the analyzing unit analyzes the communication packets, and determines that there are the similar packets when there are the communication packets with a same destination.

8. The communication device according to claim 1, wherein, when the similar packets have different sources, the compressing unit compresses the communication packets corresponding to the similar packets by issuing a virtual source representing a tentative source for singularizing the different sources, and generating a communication packet including the issued virtual source and the same destination shared among the similar packets.

9. The communication device according to claim 8, wherein the compressing unit stores the virtual source associated with the different sources of the respective similar packets as decompression information to be used in decompression.

10. The communication device according to claim 9, further comprising a decompressing unit that decompresses the communication packets, wherein
the determining unit determines whether the communication packets are to be decompressed, and
the decompressing unit decompresses the communication packet determined to be decompressed, based on the decompression information.

11. The communication device according to claim 10, wherein the determining unit determines that a communication packet is to be decompressed when the source of the communication packet is the virtual source.

12. The communication device according to claim 10, wherein the decompressing unit decompresses the communication packet determined to be decompressed, by generating a communication packet having a source stored in the decompression information in a manner associated with the virtual source, as a destination.

13. The communication device according to claim 1, wherein the communicating unit identifies a communication path for the communication packet based on a calculated value calculated from the destination of the communication packet, determines a next transfer point for the communication packet from the identified communication path, and transmits the communication packet to the determined transfer point.

14. A communication method comprising:
determining whether a received communication packet is to be compressed;
storing the communication packet determined to be compressed;
analyzing a plurality of stored communication packets, and determining whether the communication packets include any similar packets having similar process requests, based on a result of analysis;
compressing the communication packets corresponding to the similar packets when the communication packets are determined to include some similar packets; and
transmitting the compressed communication packet.

15. A non-transitory computer-readable recording medium that stores therein a computer program for causing a computer to execute a communication method, the method comprising:
determining whether a received communication packet is to be compressed;
storing the communication packet determined to be compressed;
analyzing a plurality of stored communication packets, and determining whether the communication packets include any similar packets having similar process requests, based on a result of analysis;
compressing the communication packets corresponding to the similar packets when the communication packets are determined to include some similar packets; and
transmitting the compressed communication packet.
